(19) United States
(12) Patent Application Publication
(10) Pub. No.: US 2008/0096009 A1
(43) Pub. Date: Apr. 24, 2008

(54) High Frequency Soft Magnetic Materials With Laminated Submicron Magnetic Layers And The Methods To Make Them

(75) Inventors: John Q. Xiao, Newark, DE (US); Yuwen Zhao, Newark, DE (US); Xiaokai Zhang, Newark, DE (US)

Correspondence Address: RATNERPRESTIA, P.O. BOX 1596, WILMINGTON, DE, 19899, US

(73) Assignee: UNIVERSITY OF DELAWARE, Newark, DE (US)

(21) Appl. No.: 11/630,311

(22) PCT Filed: Jun. 7, 2005
(86) PCT No.: PCT/US05/19991

§ 371 Date: Oct. 5, 2007

Related U.S. Application Data
(60) Provisional application No. 60/582,578, filed on Jun. 24, 2004.

(51) Int. Cl. B32B 15/18

(52) U.S. Cl. 428/332; 427/132

(57) ABSTRACT

A soft magnetic nanocomposites (SMNC) which contains laminated thin flakes of magnetic materials coated with an insulating material wherein the thickness of the flake is from 100 nm to 20 μm. The invention also relates to a process to make laminated thin flakes of magnetic materials.

### RELATED APPLICATIONS

This application claims benefit to U.S. Provisional application No. 60/582,578 field on Jun. 24, 2004 which is incorporated by reference in its entirety for all useful purposes.

### GOVERNMENT LICENSE RIGHTS

The United States Government has rights in this invention as provided for by U.S. Defense Advanced Research Program Agency (DARPA), Grant No. F33615-01-2-2166.

### BACKGROUND OF THE INVENTION

With the increasing rotational speed of motors and generator, and the miniaturization factor of power transformers and DC-DC converters, and the demand of high frequency electronics, magnetic core material operating at much high frequencies (MHz) are highly demanded. The conventional materials such as laminated silicon steel, compacted polymer coated magnetic powder (ex. Fe powder cores), and ferrites are currently used in order to minimize the power loss associated with eddy-current generated at high frequency. Laminated silicon steels and Fe powder core with high magnetic flux density are used for the frequency range of DC to 10 kHz; and for the frequency range of 10 kHz to about 10 MHz, soft ferrites are usually used but the magnetic flux density of ferrites are lower than 0.5 Tesla, limiting their uses in power applications. The ferromagnetic resonant frequency, the upper limit of operating frequency, is also low in common soft ferrites. Electrically insulated magnetic powder cores have much higher flux density up to 1.5 T, and ferromagnetic resonant frequency in the GHz range. However, high eddy current loss within individual particles, limiting their applications below a few hundreds kHz.

There are many inventions dealing with the fabrication of electrically insulated iron (Fe)-based core powders. The insulation coating materials are almost exclusively thermoplastic resin (U.S. Pat. Nos. 5,268,140, and 5,754,936), ceramics like MgO (U.S. Pat. No. 6,562,458) and inorganic salts like phosphate (WO 95/29490). Again, all these materials do not have reasonable permeability and quality factor at operating frequency higher than 100 kHz.

### SUMMARY OF THE INVENTION

An object of the present invention is to increase the operating frequency up to at least 10 MHz, and preferably at least 100 MHz, and up to at least 1 GHz. This represents a factor of 100 to 1,000 in terms of device miniaturization compared with materials operated at 100 kHz. The invented materials have superior frequency response compared to laminated steel and Fe powder core at frequency above 10 kHz, and can handle higher power than current ferrites. The frequency response is also better than most ferrites at frequency higher than 1 MHz.

The invention relates to a laminated flakes which comprises a magnetic material flake coated with an insulating material wherein the thickness of the flakes is from 100 nm to about 20 micron.

The invention also relates to a process for the preparation of high frequency soft materials which comprises

a. mechanically deforming, such as but not limited to mechanical ball milling, polymer or other insulator coated metallic magnetic powders to form thin flakes of magnetic material,

b. coating of said thin flakes of magnetic material with an insulating material to form a laminated flakes.

The invention can also be practiced with a further step c. Step c is the consolidation of laminated flakes to form dense bulk materials, dubbed as soft magnetic nanocomposites (SMNC).

### BRIEF DESCRIPTION OF THE FIGURES

FIG. 1 illustrates four different views. FIG. 1 illustrates a parent polymer coated magnetic powders. The magnetic powders were Fe powders;

FIG. 1b illustrates Fe thin flakes by controlled mechanical deformation, such as, but not limited to ball-milling of a;

FIG. 1c illustrates Fe thin flakes coated with an insulating layer such as but not limited to silica; and

FIG. 1d illustrates a cross-section of a SMNC.

FIG. 2 illustrates hysteresis loops of parent polymer coated Fe powders, Fe thin flakes by controlled ball-milling, and laminated Fe flakes coated with silica.

FIG. 3 illustrates the real part of permeability (μ′) spectrum of consolidated samples from parent Fe powders, Fe flakes, and consolidated laminated Fe (Fe SMNC).

### DETAILED DESCRIPTION OF THE INVENTION

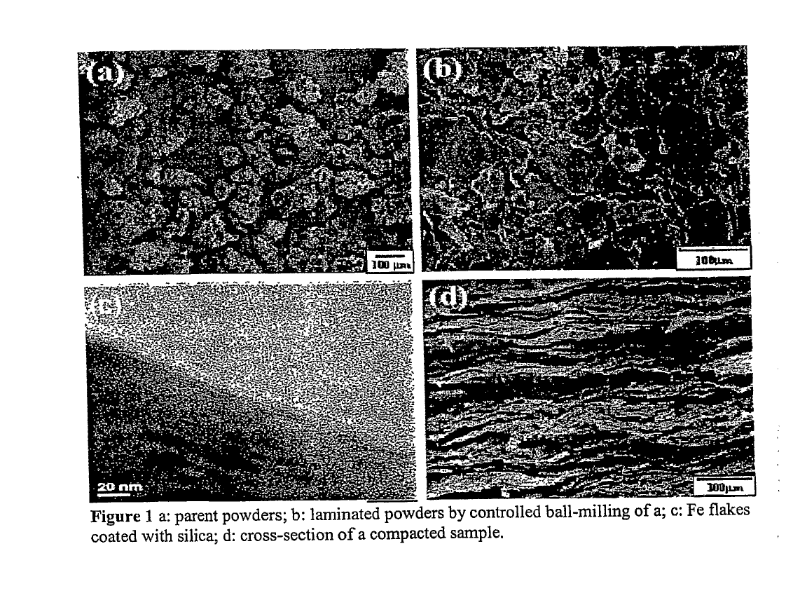

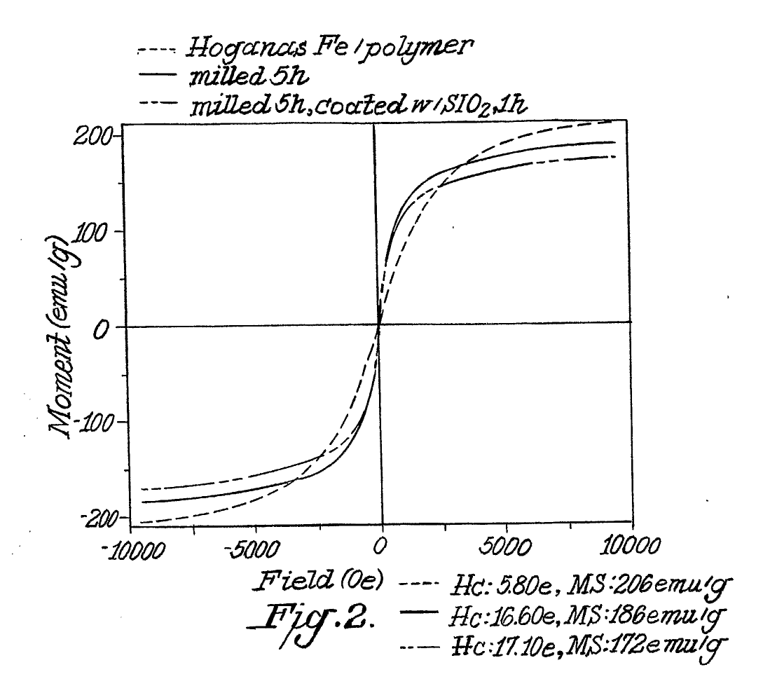

The current invention differs from prior art technology in three main aspects: The first is the Fe-based or other magnetic powders are processed to have thin flake structure (see FIG. 1b) with lateral dimension of a few to a few hundreds microns, preferably from 10 μm to 500 μm and thickness of 100 nm to 20 μm and preferably from 500 nm to 5 μm.

The second is controlled coating of such the magnetic flake such as Fe thin flakes with insulating materials, such as, but not limited to SiO₂, Al₂O₃, MgO by base-catalyzed sol-gel technique or other known coating techniques, and such as, but not limited to polyetherimide (PEI), polyether ether ketone (PEEK) by wet and dry coating techniques or other known coating techniques. All insulating materials work as long as they do not react with core materials. Insulating materials include oxides. The third is the alignment of flakes during the consolidation process. Although, the examples are shown with iron, (Fe) as the magnetic material, the process should work with other magnetic materials like FeNi, Ni, FeCo, and alloys based on Fe Co, and Ni.

The current invention can extend the operating frequency of magnetic cores based on metallic Fe, Co, Ni and their alloys to at least 10 MHz, and preferably at least 100 MHz, without significant increase of eddy-current power loss. This is because of the two advantageous factors of the current invention: 1) the laminated structure with flake thickness is smaller than the skin depth of electromagnetic field penetration, whereas conventional laminated silicon steel core and Fe powder cores have the thickness much larger than the skin depth. The latter result in significant eddy current loss at frequency higher than 100 kHz. 2) The insulating layer provides a very good electric insulation between the laminated Fe flakes, eliminating the conducting loops for eddy currents.

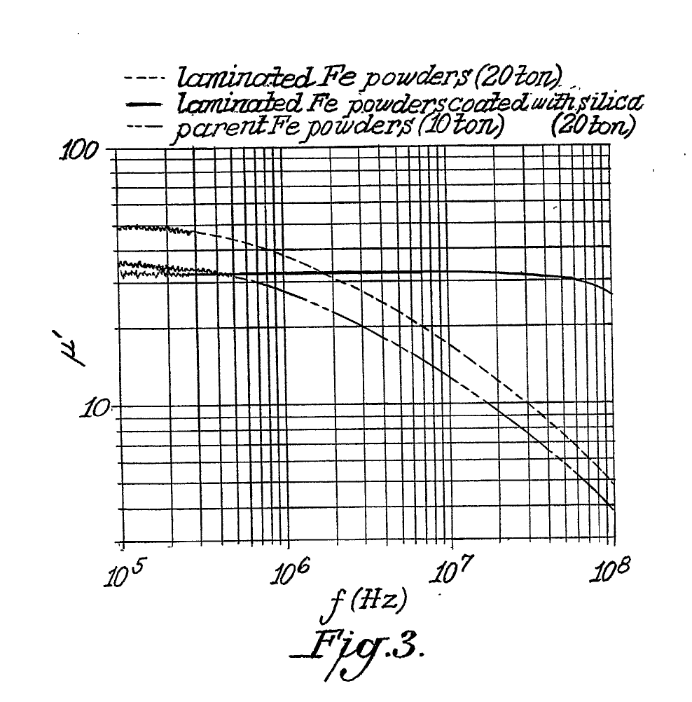

Several striking results were obtained for Fe SMNC: 1) the laminated Fe flakes are predominately parallel to each other and is along the magnetic flux direction (see FIG. 1d), which effectively prevent eddy-current formation and gives rise to high permeability; 2) permeability (real part μ′) values of 30 to 40 are observed up to 30 MHz (see FIG. 3, blue line). The permeability can be further increased using parent materials with higher permeability and post thermal treatment.

The current invention is a new process to make high frequency soft magnetic composites. The structure comprise laminated Fe thin flakes or other magnetic flakes with lateral dimension of a few to a few hundreds microns and thickness of 100 nm to 10 μm. The metallic Fe or other magnetic flakes are coated with a thin layer of insulator that will electrically isolate the flakes from each other.

### EXAMPLES

### Example 1

Two third volume of a 50 ml stainless steel ball-mill cylinder jar (SPEX 8000M Certiprep) was loaded with 20 g polymer coated Fe powders and 110 g stainless-steel balls. The milling time was controlled between 2 to 5 hours (preferably between 2 to 3.5 hours). After milling, 10 g Fe flakes were dispersed into 200 ml 2-propanol solution and sonicated for 10 minutes; 40 ml tetraethoxysilane (TEOS) and 20 ml 25% NH₃.H₂O solution were added into above dispersion and the mixture was vigorously stirred for 1 to 3 (preferably 1 to 2) hours to allow the hydrolysis reaction and condensation. By means of magnetic decantation, the silica coated Fe flakes were separated from the supernatant solution. The coated sheets were washed twice using 100 ml ethyl alcohol and 100 ml acetone to remove any un-reacted organic chemicals. The materials were finally dried in a desiccator. The original Fe powders and laminated Fe flakes were compacted into toroid samples with outer diameter of 20.08 mm, inner diameter of 13.55 mm and thickness of 1˜5 mm under static pressure of about 82 psi. Table 1 shows the data of separated core loss per cycle for cores made of original powders and Fe SMNC, where Pₜ, Pₕ and Pₑ are the total loss, hysteresis loss, and eddy-current loss per cycle, respectively.

TABLE 1
Data of core loss per cycle for original
powder cores and SMNC cores.

| | Measure at | | | | | | | | |
|---|---|---|---|---|---|---|---|---|---|
| | Bₘₐₓ = 100 G, | | | Bₘₐₓ = 3 kG | | | Bₘₐₓ = 6 kG | | |
| | f = 800 kHz | | | f = 16 kHz | | | f = 6 kHz | | |
| | (×10⁻⁷ J · cm⁻³) | | | (×10⁻⁴ J · cm⁻³) | | | (×10⁻⁴ J · cm⁻³) | | |
| Cores | Pₜ | Pₕ | Pₑ | Pₜ | Pₕ | Pₑ | Pₜ | Pₕ | Pₑ |
| Original | 22.56 | 4.96 | 17.60 | 3.26 | 2.02 | 1.24 | 8.50 | 5.64 | 2.86 |
| SMNC | 12.10 | 8.92 | 3.18 | 6.27 | 6.02 | 0.25 | 20.59 | 18.50 | 2.09 |

### Example 2

50 ml stainless steel ball-mill cylinder jar (SPEX 8000M Certiprep) was loaded with 150 g stainless-steel balls and 30 g Fe powders with polymer and oxides coating. The milling time was controlled between 45 to 100 minutes (preferably between 60 to 80 minutes). After milling, 10 g Fe flakes were dispersed into 100 ml trichloromethane (CHCl₃, chloroform) solution with 0.05M/L poly-(bisphenol A-co-4-nitrophthalic anhydride-co-1,3-phenylenediamine) (PEI). The mixture was vigorously stirred for 10 to 30 (preferably 15) minutes to allow the coating on surface of Fe flakes. By means of magnetic decantation, the PEI coated Fe flakes were separated from the solution. The coated flakes were washed twice using 100 ml ethyl alcohol and 100 ml acetone to remove any un-reacted organic chemicals. The laminated flakes were finally dried in a desiccator at 60-70° C. The dried and laminated flakes can be further consolidated.

### Example 3

50 ml stainless steel ball-mill cylinder jar (SPEX 8000M Certiprep) was loaded with 150 g stainless-steel balls 50 g commercial Ni₅₀Fe₅₀ powders. The powder is pre-coated with 2.1 wt % PEI polymer. The milling time was controlled between 90 to 150 minutes (preferably between 100 to 130 minutes). After milling, 20 g NiFe flakes were mixed with 1 g polyethylene (PE) and dry-milled in the same 50 mL-milling jar for 10 minutes, resulting PE coated NiFe flakes.

### Example 4

50 ml stainless steel ball-mill cylinder jar was loaded with 150 g stainless-steel balls and 35 g commercial Ni₇₉Fe₁₇Mo₄ powders. The powder is pre-coated with 1.3 wt % PEI polymer. The milling time was controlled between 80 to 130 minutes (preferably 110 minutes). After milling, 10 g of NiFeMo flakes were coated with silica with tetraethoxysilane (TEOS) (method described in example 1). The coating thickness can be adjusted by changing reaction time from 15 minutes to 2 hours (0.9 wt % to 2.5 wt %)

### Example 5

50 ml stainless steel ball-mill cylinder jar was loaded with 150 g stainless-steel balls and 40 g iron powders with 0.65 wt % polymer coating. The milling time was controlled between 45 to 100 minutes (preferably 60 minutes). After milling, iron flakes are compacted directly into toroid with ID=13.55 mm/OD=20.1 mm without further coating process. The ring has lower critical frequency than samples with coating but still has stable permeability spectrum up to 5 MHz.

### Example 6

50 ml stainless steel ball-mill cylinder jar was loaded with 150 g stainless-steel balls and 50 g iron powders with 0.8 wt % polymer/oxides coating. The milling time was controlled between 60 to 180 minutes (preferably 100 minutes). After milling, 10 g of Fe flakes were coated with silica with tetraethoxysilane (TEOS) (method described in example 1) for 2 hours and this process is repeated twice. The final coating thickness is over 3.3 wt % and the material has lower permeability but stable frequency spectrum nearly up to 100 MHz.

### Example 7

50 ml stainless steel ball-mill cylinder jar was loaded with 150 g stainless-steel balls and 50 g iron powders with polymer/oxides coating. The milling time was controlled at 100 minutes. After milling, 10 g of Fe flakes were coated with silica with tetraethoxysilane (TEOS) (method described in example 1) for 1 hour and the coated laminates were compacted into toroids and thermal treated In Ar, Ar+H₂, N₂ or vacuum at 300° C., 400° C., 450° C., 550° C., 600° C., 650° C. and 750° C.

### Example 8

50 ml stainless steel ball-mill cylinder jar was loaded with 150 g stainless-steel balls and 30 g iron powders with 0.6 wt % polymer/oxides coating. The milling time was controlled at 60 minutes (preferably 100 minutes). The product was then annealed in 650° C. H₂ atmosphere for 1 hour. After annealing, 10 g of Fe flakes were coated with silica with tetraethoxysilane (TEOS) (method described in example 1) for half hours to achieve a coating thickness around 1.0 wt % and the material has about 30% higher permeability compared to untreated samples.

The process for the preparation of such high frequency SMNC is composed of the following key steps:

a. Controlled mechanical deformation of polymer coated Fe or other magnetic powders to form thin flakes of Fe or other magnetic materials with lateral dimension of a few to a few hundreds microns and thickness of 100 nm to 20 μm;

b. Controlled coating of such flakes of Fe or other magnetic materials with insulating materials such as, but not limited to SiO₂, Al₂O₃, MgO by base-catalyzed sol-gel technique or other known coating techniques, and such as, but not limited to polyetherimide (PEI), polyether ether ketone (PEEK) by wet and dry coating techniques or other known coating techniques.

c. consolidate such coated materials into final soft magnetic nanocomposite (SMNC).

The materials produced by the current invention can be used as soft magnetic core materials with high magnetic flux density at frequencies >100 kHz that is untenable for the conventional laminated silicon steels and compacted Fe powder core. In particularly, these materials can be used as power transformers, motors and generators, high frequency inductors, and DC-DC converters. The importance is shown in DC-DC converters as an example, the current U.S. and worldwide market are $2 billion in the U.S. and $4 billion dollars worldwide, and will reach about $2.4 billion and $5 billion, respectively in 2007.

The main disadvantage is the operating temperature is not as high as current ferrites, but is much better than Fe powder core, and is comparable to laminate steel. The problem is likely to be overcome to use different insulating coatings such MgO which do not react with Fe at high temperatures.

All the references described above are incorporated by reference in its entirety for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

We claim:

1. A thin flake material which comprises a metallic magnetic material coated with an insulating material to form a thin flake, wherein the thickness of the flake is 100 nm to 20 μm.

2. The material as claimed in claim 1, wherein said insulating material is SiO₂, Al₂O₃, MgO, polyetherimide (PEI), or polyether ether ketone (PEEK).

3. The material as claimed in claim 1, wherein said magnetic material is iron.

4. The material as claimed in claim 2, wherein said magnetic material is iron.

5. The material as claimed in claim 1, wherein said magnetic material is FeNi, Ni, FeCo, or alloys based on Fe, Ni, or Co.

6. The material as claimed in claim 2, wherein said magnetic material is FeNi, Ni, FeCo, or alloys based on Fe, Ni, or Co.

7. The material as claimed in claim 1, wherein said thickness of the flake is from 100 nm to 20 μm.

8. The material as claimed in claim 2, wherein said thickness of the flake is from 100 nm to 20 μm.

9. A process for the preparation of high frequency soft magnetic nanocomposites which comprises the steps of
a. mechanically deforming polymer coated metallic magnetic material powders to form a metallic magnetic thin flake,
b. coating of said metallic magnetic thin flake with an insulating material to form a laminated material.

10. The process as claimed in claim 9, wherein said mechanically deforming is by mechanical ball milling.

11. The process as claimed in claim 9, which further comprises a step of consolidation said laminated material into a final product.

12. The process as claimed in claim 9, wherein said insulating material is SiO₂, Al₂O₃, MgO, polyetherimide (PEI), or polyether ether ketone (PEEK).

13. The process as claimed in claim 9, wherein said magnetic material is iron.

14. The process as claimed in claim 12, wherein said magnetic material is iron.

15. The process as claimed in claim 9, wherein said magnetic material is FeNi, Ni, FeCo, or alloys based on Fe, Ni, or Co.

16. The process as claimed in claim 12, wherein said magnetic material is FeNi, Ni, FeCo, or alloys based on Fe, Ni, or Co.

17. The process as claimed in claim 9, wherein said thickness of the flake is from 100 nm to 20 μm.
